(19) United States
(12) Patent Application Publication
(10) Pub. No.: US 2008/0271352 A1
(43) Pub. Date: Nov. 6, 2008

(54) Traffic Sign Apparatus

(75) Inventors: Takeshi Nakayama, Tokyo (JP); Akira Abe, Tokyo (JP); Dai Shimizu, Tokyo (JP); Fumihiro Itoshima, Saitama (JP); Kazuo Harada, Saitama (JP); Masahiro Oda, Saitama (JP); Yasuhiro Makii, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: LINTEC CORPORATION, Tokyo (JP)

(21) Appl. No.: 10/585,870

(22) PCT Filed: Jan. 19, 2005
(86) PCT No.: PCT/JP2005/000568

§ 371 Date: Jul. 10, 2008

(30) Foreign Application Priority Data
Jan. 19, 2004 (JP) 2004-010484

(51) Int. Cl. G09F 13/02

(52) U.S. Cl. 40/543

(57) ABSTRACT

There is provided a traffic sign apparatus that can improve the luminance of a sign surface which emits light by ultraviolet irradiation, and the uniformity ratio of illuminance, so as to enhance the visibility thereof in the nighttime. The traffic sign apparatus 10 includes a sign body 11 having the sign surface 14 which emits light by ultraviolet irradiation, and an irradiation device 12 for irradiating ultraviolet rays onto the sign surface 14. Assuming that the maximum incident angle of the ultraviolet rays be θ1, the ultraviolet rays being irradiated from the ultraviolet emission lamps 26 of the irradiation unit 12 onto the objective sign surfaces W1 and W2 on the sign surface 14 which is the irradiation object of the ultraviolet emission lamps 26; and that the minimum incident angle be θ2, the angle θ1 is set to more than 30° and less than 70°; and the angle θ 2 is set to more than 5° and less than 30°.

### TECHNICAL FIELD

The present invention relates to a traffic sign apparatus, particularly to a traffic sign apparatus not giving dazzling feeling even in the nighttime and being visible in wide-angle range and also from a long distance.

### BACKGROUND ART

Conventionally, a traffic sign apparatus, which is disposed above traffic lanes for displaying route guidance or the like, has been widely employed in expressways and the like. As such traffic sign apparatus, for example, a traffic sign apparatus of a type disclosed in the patent document 1 is known. In the traffic sign apparatus disclosed in the patent document 1, the sign surface is formed of a retroreflective sheet, and is arranged so that visible light, which is irradiated from an irradiation device disposed on the road shoulder, is reflected on the sign surface so as to ensure the visibility of the sign surface in the nighttime.

However, in such the traffic sign apparatus, there is a possibility that drivers on the opposite lane may occasionally look directly at the irradiation device and the irradiation device dazzles and interferes with the driving. Also, light beam of visible light outgoing outside the sign surface can be occasionally seen in a strip-shaped, and thereby drivers may be dazzled by diffused reflection in rainy or foggy condition. Further, depending on the angle at which a driver looks at the sign surface, the sign surface may look dark or the reflected light may be too strong, thus adversely decreasing the visibility thereof.

Hence, as a traffic sign apparatus not using the visible light, for example, there is known a traffic sign apparatus of a type disclosed in the patent document 2. The traffic sign apparatus disclosed in the patent document 2 has such an arrangement that the sign surface is formed using paint including fluorescent material, which emits fluorescence by ultraviolet rays, and the sign surface is irradiated with ultraviolet rays from an irradiation device, and thereby the disadvantage due to visible light is eliminated and the visibility of the sign surface in the nighttime is improved.

Patent document 1

Japanese Patent Publication No. 2910868

Patent document 2

Japanese Utility Model Registration No. 2597803

### DISCLOSURE OF THE INVENTION

### Problems to be Solved by the Invention

However, when an irradiation device was installed on the ground to irradiate the sign surface as described in the patent document 2 (refer to paragraph “0024”), the inventors of the present invention found various disadvantages to be improved in the uniformity ratio of illuminance on the sign surface, the luminance and the like of the sign surface.

Specifically, when the sign body located above traffic lanes is irradiated with ultraviolet rays from an irradiation device installed on the road shoulder, sufficient definition of the sign surface is not obtained depending on the distance between the irradiation device and the sign body and/or the incident angle of the ultraviolet rays, resulting in such a disadvantage that the sign surface looks dark with poor visibility when seen from a long distance.

In order to obtain excellent visibility with good uniformity ratio of illuminance on the sign surface and luminance of the sign surface, the inventors therefore conducted experiments under various conditions. As a result, the inventors found that there are certain principles that exerted excellent effects on visibility of the sign surface in the matter of relative positional relationship between the sign surface and the irradiation device, the performance of the irradiation device and the like.

### OBJECT OF THE INVENTION

The present invention has been proposed based on the above views. An object of the present invention is to provide a traffic sign apparatus capable of enhancing visibility for drivers in the nighttime through improvement of luminance and uniformity ratio of illuminance of a sign surface which emits light by ultraviolet irradiation.

Another object of the invention is to provide a traffic sign apparatus capable of facilitating the installation work and adjusting operation of a sign body and an irradiation device.

### Means for Solving the Problem

In order to achieve the above object, the present invention adopts such an arrangement in a traffic sign apparatus that comprises:

a sign body having a sign surface which emits light by ultraviolet irradiation; and

an irradiation device for irradiating ultraviolet rays onto the sign surface,

wherein, assuming that the maximum incident angle of ultraviolet rays be θ1, the ultraviolet rays being irradiated from an irradiation source of the irradiation device onto an objective sign surface on the sign surface that is an irradiation objective of the irradiation source, and that the minimum incident angle be θ2, the angle θ1 is set to more than 30° and less than 70°, and the angle θ2 is set to more than 5° and less than 30°.

In the present invention, it is preferable to adopt such an arrangement in the traffic sign apparatus in which assuming that a distance between the irradiation source and the sign surface along a reference axial direction of the sign surface be X, and that the sum of distances between the irradiation source and side end of the sign surface closer to the irradiation device along a surface direction of the sign surface and the width of the sign surface be M,

the irradiation source is disposed so that X/M is more than 0.5 and less than 2.0 with respect to the sign surface.

The irradiation unit preferably adopts such an arrangement that irradiation device has a plurality of irradiation units, each of which includes the irradiation source and an irradiating surface section having a reflection surface for reflecting the ultraviolet rays irradiated from the irradiation source, and the irradiation angles of the ultraviolet rays of the plurality of irradiation units are different from each other.

Also, such an arrangement may be adopted that the irradiation source has a light emitting tube of quartz glass.

Further, the following arrangement may be preferably adopted; the surface of the sign surface is processed with a dirt-proof processing.

### ADVANTAGE OF THE INVENTION

According to the invention, the uniformity ratio of illuminance on the sign surface and the luminance of the sign surface are satisfactorily ensured as will be demonstrated in table 5, and it becomes possible to make the sign surface more visible and recognizable.

Since the distance X is set up as described above, when the sign body is disposed above the traffic lanes and the irradiation device is disposed on the road shoulder, the sign body and the irradiation device are positioned relatively close to each other. Owing to this, it makes possible to prevent the ultraviolet rays from being subjected to following influences; i.e., plants positioned between the sign body and the irradiation device intercept the ultraviolet rays; or the ultraviolet rays are diffused by rain or snow. And further, the angle and/or direction of the irradiation device can be easily adjusted in the installation work thereof. Accordingly, the time for maintenance service such as cleaning can be reduced.

Further, since the irradiation angles of the ultraviolet rays of the plurality of irradiation units are different from each other, for example, the irradiation angle of the irradiation unit incident axis of which is short can be set wider than that of the irradiation unit incident axis of which is long. In other words, since the irradiated ultraviolet rays are diffused more widely, the intensity of the ultraviolet rays on the sign surface can be distributed uniformly. Accordingly, the entire sign surface can emit light effectively, and good uniformity ratio of illuminance can be obtained.

Furthermore, since the light emitting tube is formed of a quartz glass, the ultraviolet transmittance of the light emitting tube is increased, resulting that the intensity of the ultraviolet rays is strengthened and the luminance of the sign surface is intensified.

Still further, when the surface of the sign surface is processed with dirt-proof processing, the sign surface is prevented from being adhered with dust and the like. Owing to this, the amount of the ultraviolet rays reaching the sign surface can be prevented from being reduced, and thus the luminance of the sign surface can be stably maintained, and in addition maintenance work can be facilitated.

Here, in the description and claims of the invention, the wording “incident angle” means the angle between the reference axis and the incident axis. The wording “reference axis” means an axial line perpendicular to the sign surface at the point where the ultraviolet rays from the irradiation source enters which is indicated with chain lines in FIG. 1. Further, the wording “incident axis” means an axial line defined by the path of the ultraviolet rays from the irradiation source to the incident point on the sign surface, which is indicated with broken lines in FIG. 1.

### BRIEF DESCRIPTION OF THE DRAWINGS

FIG. 1 is a perspective view schematically showing a traffic sign apparatus in accordance with an embodiment.

FIG. 2 is a partially enlarged sectional view of a sign body.

FIG. 3 is a partially enlarged cross sectional view of a first and second irradiation units.

FIG. 4 is an enlarged front view of a sign surface.

### EXPLANATION OF REFERENCE NUMERALS

10 traffic sign apparatus
11 sign body
12 irradiation device
14 sign surface
23 first irradiation unit
24 second irradiation unit
26 ultraviolet emission lamp (irradiation source)
26A light emitting tube
27 irradiating surface section
27A reflection surface

### BEST MODES FOR CARRYING OUT THE INVENTION

Hereinafter, an embodiment of the invention will be described with reference to the drawings.

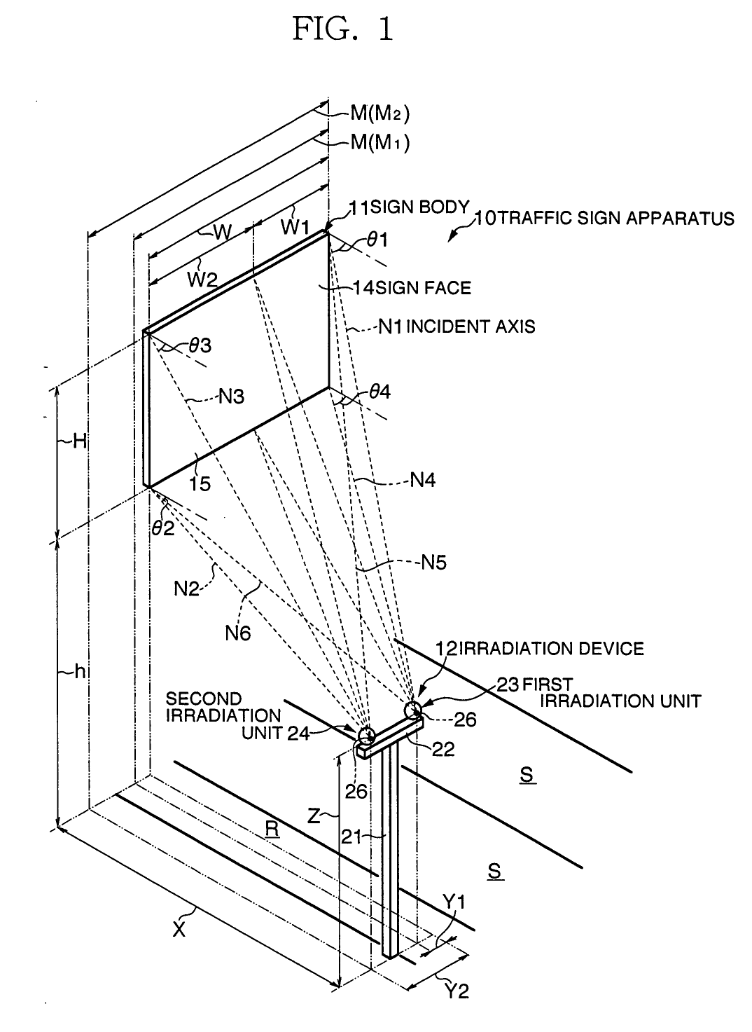

FIG. 1 is a perspective view schematically showing a traffic sign apparatus in accordance with the embodiment. Referring to FIG. 1, a traffic sign apparatus 10 comprises a sign body 11 disposed above traffic lanes S and an irradiation device 12 that irradiates ultraviolet rays from diagonally under the sign body 11.

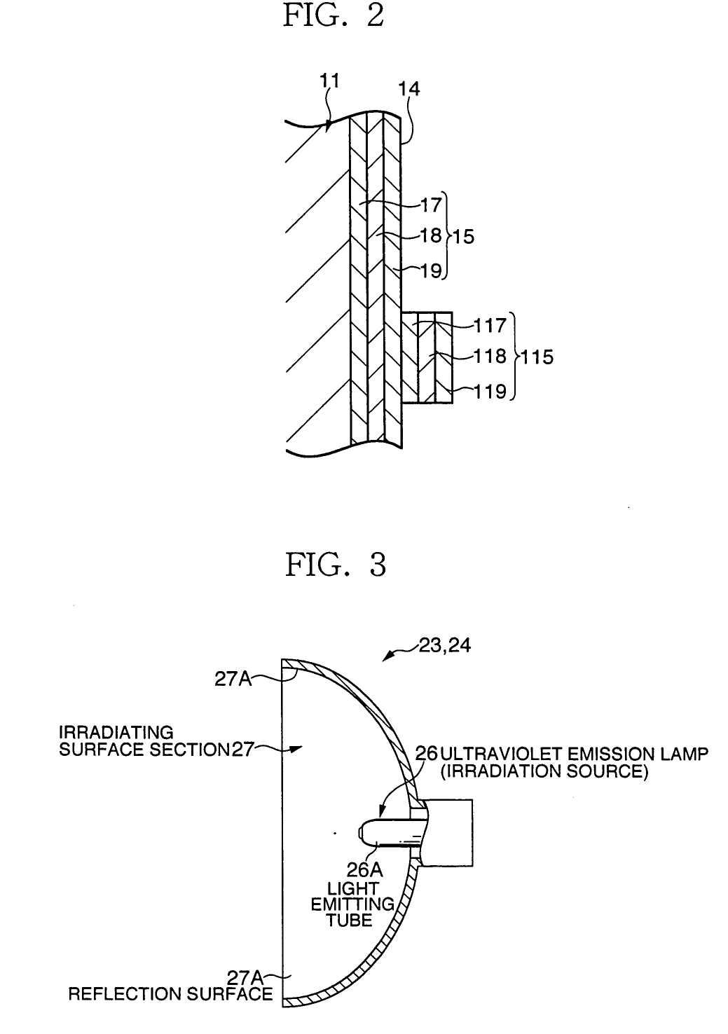

The sign body 11 is supported via a support member (not shown) located outside or the like of the road shoulder R. The sign body 11 has a sign surface 14 that is luminous via ultraviolet irradiation from the irradiation device 12. The sign surface 14 is formed of film member 15 stuck with an adhesive (not shown) on the front surface of the sign body 11 in FIG. 1. As shown in FIG. 2, the film member 15 includes a reflection layer 17 stuck on the right-side surface of the sign body 11 in FIG. 2, a light emitting layer 18 laminated on the reflection layer 17 and a substantially transparent dirt-proof layer 19 laminated on the light emitting layer 18.

The reflection layer 17 is formed of, for example, a polyurethane resin, and is subjected to a treatment exerting a concealing function for enhancing the luminance of the light emitting layer 18 when irradiated with ultraviolet rays. The light emitting layer 18 is formed of a polyurethane resin blended with inorganic fluorescent pigments, which emits light by ultraviolet rays. In addition, the dirt-proof layer 19 is formed of an acrylic resin which exerts dirt-proof processing effect preventing dirt from being adhered onto the surface of the sign surface 14.

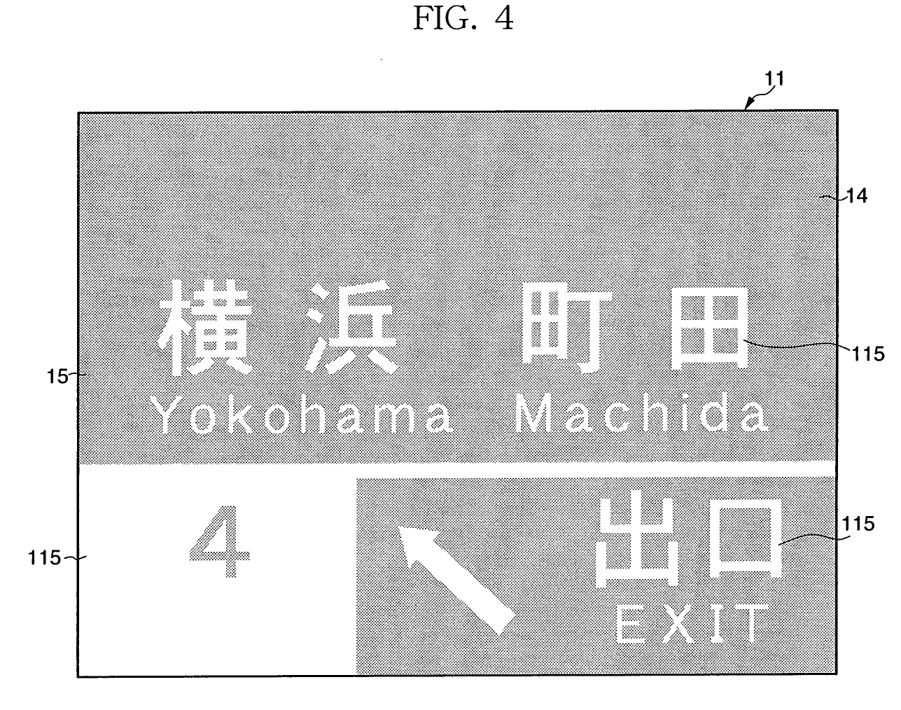

Note that, as shown in FIG. 2, on the surface of the film member 15, characters and figures shown in FIG. 4 are formed on the sign surface 14 by sticking indication members 115 forming characters and figures by adhesive (not shown). As for the indication members 115, the same constituents as those for the film member 15 are used. That is, the indication members 115 include a reflection layer 117, a light emitting layer 118 laminated on the reflection layer 117 and a dirt-proof layer 119 laminated on the light emitting layer 118. In this embodiment, the sign body 11 is arranged to form as described below. That is, a luminous film member 15, which is colored with a substantially green (indicated with a halftone dots in FIG. 4), is stuck to the sign body 11, and the luminous indication members 115, which are colored with a substantially white (the area indicated other than the halftone dots in FIG. 4), are stuck to the surface of the film member 15.

As shown in FIG. 1, the irradiation device 12 comprises a support post 21 disposed outside the road shoulder R extending upward, a lateral arm 22 provided on the upper end of the support post 21 extending in the direction across the traffic lane S, and a first irradiation unit 23 (irradiation unit at the right side in FIG. 1) and a second irradiation unit 24 (irradiation unit at the left side in FIG. 1), which are attached to the upper side of the lateral arm 22.

The first and second irradiation units 23 and 24 have substantially identical structure and are connected to a predetermined power source so as to be capable of irradiating ultraviolet rays. As shown in FIG. 3, each of the irradiation units 23 and 24 comprises respectively an ultraviolet emission lamp 26 as the irradiation source, which has a light emitting tube 26A formed of a quartz glass, and an irradiating surface section 27, which is formed in a parabolic shape enclosing the outside of the ultraviolet emission lamp 26, with its open side (left side in FIG. 3) oriented to the sign surface 14.

The ultraviolet emission lamp 26 in the first irradiation unit 23 is arranged so as to irradiate an objective sign surface W1 at the right side of the sign surface 14 in FIG. 1 as the object to be irradiated with ultraviolet rays. On the other hand, the ultraviolet emission lamp 26 in the second irradiation unit 24 is arranged so as to irradiate an objective sign surface W2 at the left side of the sign surface 14 in FIG. 1 as the object to be irradiated with ultraviolet rays. Here, for the convenience of illustration, the sign surfaces W1 and W2 are indicated as shown in FIG. 1. However, there is no definite boundary between the objective sign surfaces W1 and W2. Therefore, there may be an area where the objective sign surfaces W1 and W2 are overlapped with each other.

The irradiating surface section 27 includes a reflection surface 27A that reflects the ultraviolet rays irradiated from the ultraviolet emission lamp 26 at the inner face side thereof. Incidentally, the first and second irradiation units 23 and 24 are arranged so as to have a wide irradiation angle by forming a rough surface such as satin crape finish or the like on the reflection surface 27A. Alternatively, the reflection surface 27A may be mirror-finished to increase the reflectance of the ultraviolet rays to allow the same to travel a long distance.

Here, the relative position between the sign surface 14 and the ultraviolet emission lamps 26 of the respective irradiation units 23 and 24 is set within a range of the length of the incident axis and the magnitude of the incident angle as described below.

That is, in the incident angle of the ultraviolet rays irradiated onto the sign surface 14 from the respective irradiation units 23 and 24, the angle which is formed by the incident axis N1 and the reference axis at the upper-right corner of the sign surface 14, the incident axis N1 being between the ultraviolet emission lamp 26 of the first irradiation unit 23 and the upper-right corner of the sign surface 14 in FIG. 1, comes to be the maximum incident angle θ1. On the other hand, the angle which is formed by the incident axis N2 and the reference axis at the lower-left corner of the sign surface 14, the incident axis N2 being between the ultraviolet emission lamp 26 of the second irradiation unit 24 and the lower-left corner of the sign surface 14 in FIG. 1, comes to be the minimum incident angle θ2. The angles θ1 and θ2 are set within the range expressed by the following expressions:

30°<θ1<70°

5°<θ2<30°

When the angle θ1 is 30° or less or the angle θ2 is 5° or less, the sign surface 14 becomes dark, and satisfactory visibility cannot be obtained. On the other hand, when the angle θ1 is 70° or more or the angle θ2 is 30° or more, the uniformity of illuminant on the sign surface 14 is decreased, and satisfactory visibility of the sign surface 14 cannot be obtained.

Assuming that the sum of the distance Y1, or Y2, that is, the distance between the ultraviolet emission lamp 26 and the side end of the sign face 14 closer to the irradiation device 12 (left end in FIG. 1) along the surface direction of the sign surface, and the width W of the sign surface 14, (Y1+W, Y2+W) be M, the distance X between the ultraviolet emission lamp 26 of the respective irradiation units 23 and 24 and the sign surface 14 along the reference axis direction is set within the following formula:

0.5<(X/M)<2.0

When the X/M is 0.5 or less, the uniformity of illuminant on the sign surface 14 tends to be decreased; and thus satisfactory visibility cannot be obtained on the sign surface 14. On the other hand, when the X/M is 2.0 or more, the sign surface 14 tends to be dark; and thus, satisfactory visibility is hardly obtained.

Therefore, according to the embodiment as described above, since the distance between the sign body 11 and the irradiation device 12 is to be set relatively closer to each other, the angle of the respective irradiation units 23 and 24 can be easily adjusted in the installation work thereof and the like.

Hereinafter, in order to verify the effect of the invention, examples 1 to 4 and comparative examples 1 and 2 will be described with reference to FIG. 1.

In each of the examples and comparative examples, the installation conditions of the sign body 11 and the irradiation device 12 were set as shown in tables 1 and 2. Note that, herein the road surface of the traffic lanes S and the surface of the road shoulder R are to be located on substantially same level, and the distance X, the lengths L1 to L4 of the incident axes, the incident angles θ1 to θ4, and the sums M1 and M2 of the distance in Table 2 are the following values in the configuration of FIG. 1.

The distance X, and the incident angles θ1 and θ2 are the same as those in the embodiment;

Length L1: length of the incident axis N1;

Length L2: length of the incident axis N2;

Length L3: length of the incident axis N3 between the ultraviolet emission lamp 26 of the second irradiation unit 24 and the left-upper corner of the sign surface 14 in FIG. 1;

Length L4: length of the incident axis N4 between the ultraviolet emission lamp 26 of the first irradiation unit 23 and the right-lower corner of the sign surface 14 in FIG. 1;

Incident angle θ3: angle between the incident axis N3 and the reference axis at the left-upper corner of the sign surface 14;

Incident angle θ4: angle between the incident axis N4 and the reference axis at the right-lower corner of the sign surface 14;

Sum of distance M₁: sum of distance Y1 and width W in Table 1; and

Sum of distance M₂: sum of distance Y2 and width W in Table 1

As shown in FIG. 4, in the sign surface 14, the area with halftone dots that the film member 15 exposed was arranged to be green area; and the area without halftone dots that the indication members 115 exposed was arranged to be white area. The amount of the blended inorganic fluorescent pigments for the light emitting layers 18 and 118 was arranged to be 70 g/m² for the white area, and 30 g/m² for the green area respectively. Three-color fluorescent pigments (RGB) constituting the white area was arranged to be a combination in which the luminance was the highest at the peak wavelength (365 nm) of the ultraviolet rays. For the green area, such a color was selected that the brightness is as high as possible within the x-y coordination system for green in the specifications of the Japan Highway Public Corporation. The luminance of the white area and the green area with respect to the ultraviolet intensity was set to the conditions shown in Table 3.

For the ultraviolet emission lamp 26 of the first and second irradiation units 23 and 24, lamps of 400 W were used respectively. The reflection surfaces 27A of the irradiation units 23 and 24 were formed in a rough surface or a mirrored surface as shown in table 4.

TABLE 1
Common setting conditions for respective
embodiments and comparative examples

| | | |
|---|---|---|
| Lateral width W of sign surface 14 | 3.5 | m |
| Height H of sign surface 14 | 2.65 | m |
| Vertical distance h from the road surface of the traffic | 5.0 | m |
| lane S to the lower end of the sign surface 14 | | |
| Distance Y1 between ultraviolet emission lamp 26 of first | 0.3 | m |
| irradiation unit 23 and side end of sign surface 14 closer | | |
| to irradiation device 12 | | |
| Distance Y2 between ultraviolet emission lamp 26 of | 1.2 | m |
| second irradiation unit 24 and side end of sign surface | | |
| 14 closer to irradiation device 12 | | |
| Vertical distance Z between ultraviolet lamps 26 of first | 4.0 | m |
| and second irradiation units 23 and 24 and road surface | | |

TABLE 2
Varied setting conditions for respective embodiments and comparative examples

| | Dis- | | | | | | | | | | |
|---|---|---|---|---|---|---|---|---|---|---|---|
| | tance | Length of incident axis | | | | Incident angle | | | | | |
| | X | (m) | | | | (°) | | | | | |
| | (m) | L1 | L2 | L3 | L4 | θ1 | θ2 | θ3 | θ4 | X/M₁ | X/M₂ |
| Embodiment 1 | 5.5 | 7.6 | 5.7 | 6.7 | 6.8 | 44 | 16 | 35 | 36 | 1.45 | 1.17 |
| Embodiment 2 | 5.5 | 7.6 | 5.7 | 6.7 | 6.8 | 44 | 16 | 35 | 36 | 1.45 | 1.17 |
| Embodiment 3 | 6.0 | 8.0 | 6.2 | 7.1 | 7.2 | 41 | 15 | 33 | 33 | 1.58 | 1.28 |
| Embodiment 4 | 5.5 | 7.6 | 5.7 | 6.7 | 6.8 | 44 | 16 | 35 | 36 | 1.45 | 1.17 |
| Comparative | 10.0 | 11.3 | 10.1 | 10.7 | 10.7 | 28 | 9 | 21 | 21 | 2.63 | 2.13 |
| example 1 | | | | | | | | | | | |
| Comparative | 2.5 | 5.8 | 2.7 | 4.5 | 4.7 | 65 | 32 | 56 | 62 | 0.66 | 0.53 |
| example 2 | | | | | | | | | | | |

TABLE 3

| | Intensity of ultraviolet rays (mW/cm²) | | | |
|---|---|---|---|---|
| | 0.5 | | 1.0 | 1.5 |
| White area | 14 | cd/m² | 27 cd/m² | 40 cd/m² |
| Green area | 8 | cd/m² | 15 cd/m² | 23 cd/m² |

TABLE 4

| | Reflection surface 27A | Reflection surface 27A |
|---|---|---|
| | of first irradiation | of second irradiation |
| | unit 23 | unit 24 |
| Embodiment 1 | Mirror surface | Rough surface |
| Embodiment 2 | Mirror surface | Mirror surface |
| Embodiment 3 | Mirror surface | Mirror surface |
| Embodiment 4 | Rough surface | Rough surface |
| Comparative | Mirror surface | Mirror surface |
| example 1 | | |
| Comparative | Mirror surface | Mirror surface |
| example 2 | | |

Under the above-described conditions, the sign surface 14 was irradiated with ultraviolet rays through the first and second irradiation units 23 and 24. In this state, the luminance was measured at plural arbitrary points on the sign surface 14 corresponding to the white area and the green area (KONICA MINOLTA, luminance meter LS-100). Based on the measurement result, as demonstrated in table 5, average luminance and the uniformity ratio of illuminance in the embodiments and the comparative examples were calculated.

TABLE 5

| | | | | Uniformity ratio of | |
|---|---|---|---|---|---|
| | Average luminance (cd/m²) | | | illuminance | |
| | White | Green | Entire | White | Green |
| | area | area | area | area | area |
| Embodiment 1 | 33 | 16 | 23 | 1:3.5 | 1:2.9 |
| Embodiment 2 | 36 | 17 | 24 | 1:4.3 | 1:4.0 |
| Embodiment 3 | 33 | 15 | 23 | 1:3.2 | 1:4.4 |
| Embodiment 4 | 30 | 14 | 22 | 1:3.7 | 1:4.0 |
| Comparative | 7 | 3 | 5 | 1:1.8 | 1:2.0 |
| example 1 | | | | | |
| Comparative | 105 | 51 | 74 | 1:40.7 | 1:44.0 |
| example 2 | | | | | |

As demonstrated in table 5, it will be understood that, in the embodiments 1 to 4 compared with the comparative examples 1 and 2, both of the average luminance and the uniformity ratio of illuminance were improved. Particularly, in the embodiment 1, the average luminance of the entire area was 20 cd/m² or more, and the uniformity ratio of illuminance in the white area and the green area was maintained better than 1:4; thus, superior visibility and recognizability in the nighttime can be obtained.

Note that, in the comparative example 1, the sign surface 14 becomes dark; and in the comparative example 2, the uniformity ratio of illuminance is decreased; thus, satisfactory visibility and the like are not ensured in practical use.

The best structure and method for carrying out the present invention have been disclosed so far. However, the present invention is not limited to the above.

That is, the present invention has been illustrated and described mainly about a specific embodiment. However, it is possible for those skilled in the art to add various modifications to the above-described embodiment with respect to shape, quantity, material or other detailed arrangement without departing from the technical spirit and the range of the object of the present invention.

Therefore, the above descriptions limiting the shape and the like are given for the purpose of illustrating only to facilitate the understanding of the present invention, but not to limit the present invention.

In the irradiation device 12, various design changes are possible within the magnitude range of the above-described incident angle. For example, the number of the provided irradiation devices or the range of the respective objective sign surfaces W1 and W2 may be increased or reduced depending on the installation position, size and/or shape of the sign surface 14. For example, one or three or more irradiation units may be provided. When plural irradiation units are provided, the irradiation units may be arranged to be disposed vertically or tilted direction to each other. Also, in the above embodiments, when the entire sign surface 14 is assumed to be the objective sign surface of each of the first and second irradiation units 23 and 24, the above-described positions of the maximum incident angle and the minimum incident angle may be varied depending on the objective sign surface. That is, the angle which is formed by the incident axis N5 and the reference axis at the upper-right corner of the sign surface 14, the incident axis N5 being between the ultraviolet emission lamp 26 of the second irradiation unit 24 and the upper-right corner of the sign surface 14 in FIG. 1, becomes the maximum incident angle; and the angle which is formed by the incident axis N6 and the reference axis at the lower-left corner of the sign surface 14, the incident axis N6 being between the ultraviolet emission lamp 26 of the first irradiation unit 23 and the lower-left corner of the sign surface 14 in FIG. 1, becomes the minimum incident angle. In short, it is an essential requirement of the invention that the maximum incident angle and the minimum incident angle of the ultraviolet rays, at which the ultraviolet rays are irradiated on the objective sign surface on the sign surface 14 as the irradiation object by the irradiation source such as the ultraviolet emission lamp 26 of the irradiation device 12, are set within the above-described range.

Further, as for colors used for the light emitting layer 18, various combinations of colors can be selected as far as satisfactory visibility can be obtained when the sign surface 14 is irradiated with ultraviolet rays.

Furthermore, in the embodiment, the sign surface 14 is formed by sticking the film member 15 and the indication members 115 on the surface of the sign body 11. However, the sign surface 14 may be formed with known printing method such as screen printing or the like; or the portion equivalent to the indication members 115 may be previously formed on the surface of the film member 15 via printing, and then the film member 15 may be stuck on the sign body 11 to form the sign surface 14. After all, the sign surface 14 may be formed with various known methods and the method therefor is not particularly limited.

### INDUSTRIAL APPLICABILITY

The invention is generally applicable to normal roads, expressways and the like.

1. A traffic sign apparatus, comprising:
a sign body with a sign surface which emits light by ultraviolet irradiation; and
an irradiation device which irradiates ultraviolet rays onto said sign surface,
wherein, assuming that maximum incident angle of ultraviolet rays be θ1, the ultraviolet rays being irradiated from an irradiation source of said irradiation device onto an objective sign surface on the sign surface that is an irradiation objective of the irradiation source, and that minimum incident angle be θ2, the angle θ1 is set to more than 30° and less than 70°, and the angle θ2 is set to more than 5° and less than 30°.

2. The traffic sign apparatus according to claim 1, wherein, assuming that a distance between said irradiation source and the sign surface along a reference axial direction of the sign surface be X, and that sum of distance between the irradiation source and side end of the sign surface closer to the irradiation device along a surface direction of the sign surface and width of the sign surface be M,
said irradiation source is disposed so that X/M is more than 0.5 and less than 2.0 with respect to the sign surface.

3. The traffic sign apparatus according to claim 1 or 2, wherein said irradiation device includes a plurality of irradiation units, each of the irradiation units having said irradiation source and an irradiating surface section with a reflection surface for reflecting the ultraviolet rays irradiated from the irradiation source, and wherein
irradiation angles of the ultraviolet rays of said plurality of irradiation units are different from each other.

4. The traffic sign apparatus according to claim 1 or 2, wherein said irradiation source has a light emitting tube of quartz glass.

5. The traffic sign apparatus according to claim 1 or 2, wherein surface of said sign surface is processed with a dirt-proof processing.
